(19) United States
(12) Patent Application Publication
(10) Pub. No.: US 2025/0004879 A1
(43) Pub. Date: Jan. 2, 2025

(54) ERROR CORRECTION WITH MEMORY SAFETY AND COMPARTMENTALIZATION

(71) Applicant: Intel Corporation, Santa Clara, CA (US)

(72) Inventors: David M. Durham, Beaverton, OR (US); Sergej Deutsch, Hillsboro, OR (US); Salmin Sultana, Hillsboro, OR (US); Karanvir Grewal, Hillsboro, OR (US)

(73) Assignee: Intel Corporation, Santa Clara, CA (US)

(21) Appl. No.: 18/346,034

(22) Filed: Jun. 30, 2023

(51) Int. Cl. G06F 11/10; G06F 9/30; G06F 21/60

(52) U.S. Cl. CPC G06F 11/1068; G06F 9/30043; G06F 21/602

(57) ABSTRACT

Techniques for error correction with memory safety and compartmentalization are described. In an embodiment, an apparatus includes a processor to provide a first set of data bits and a first tag in connection with a store operation, and an error correcting code (ECC) generation circuit to generate a first set of ECC bits based on a first set of data bits and a first tag.

### BACKGROUND

Computers and other information processing systems may store confidential, private, and secret information in their memories. Software may have vulnerabilities that may be exploitable to steal such information. Hardware may also have vulnerabilities that may be exploited and/or adversaries may physically modify a system to steal information. Therefore, memory safety and security are important concerns in computer system architecture and design.

### BRIEF DESCRIPTION OF DRAWINGS

Various examples in accordance with the present disclosure will be described with reference to the drawings, in which:

FIGS. 1A and 1B illustrate a computing system for error correction with memory safety and compartmentalization according to an embodiment.

FIG. 2A illustrates a cache line according to an embodiment.

FIG. 2B illustrates a linear and a physical memory address encodings according to an embodiment.

FIG. 2C illustrates a physical address encoding according to an embodiment.

FIG. 3 illustrates a method for error correction with memory safety and compartmentalization according to an embodiment.

FIG. 4 illustrates an example computing system.

FIG. 5 illustrates a block diagram of an example processor and/or System on a Chip (SoC) that may have one or more cores and an integrated memory controller.

FIG. 6(A) is a block diagram illustrating both an example in-order pipeline and an example register renaming, out-of-order issue/execution pipeline according to examples.

FIG. 6(B) is a block diagram illustrating both an example in-order architecture core and an example register renaming, out-of-order issue/execution architecture core to be included in a processor according to examples.

FIG. 7 illustrates examples of execution unit(s) circuitry.

FIG. 8 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for error correction with memory safety and compartmentalization. According to some examples, an apparatus includes a processor to provide a first set of data bits and a first tag in connection with a store operation, and an error correcting code (ECC) generation circuit to generate a first set of ECC bits based on a first set of data bits and a first tag.

As mentioned in the background section, memory safety and security are important concerns in computer system architecture and design. Some approaches to protecting memory against attacks include adding tags (e.g., metadata) to or associating tags with data stored in memory (e.g., at the granularity of a cache line, object, etc.) and comparing those stored tags to tags provided (e.g., in a memory address or pointer) in attempts to access the data. Tag comparison and/or checking operations may add cost in terms of latency, complexity, storage, memory bandwidth, etc. Approaches according to embodiments described in this specification may provide for more efficient and/or less costly tag comparison, checking, and/or storage by leveraging existing error correction and/or message authentication capabilities of computer systems. Approaches according to embodiments may support existing error correction techniques (e.g., chipkill, single device data correction (SDDC), etc.) and memory tagging with the same ECC.

Descriptions of embodiments, based on ECC, memory authentication with Galois integrity and correction (MAGIC), memory tagging, etc. techniques, are provided as examples. Embodiments may include and/or relate to other error detection, error correction, message authentication, encryption, etc. techniques.

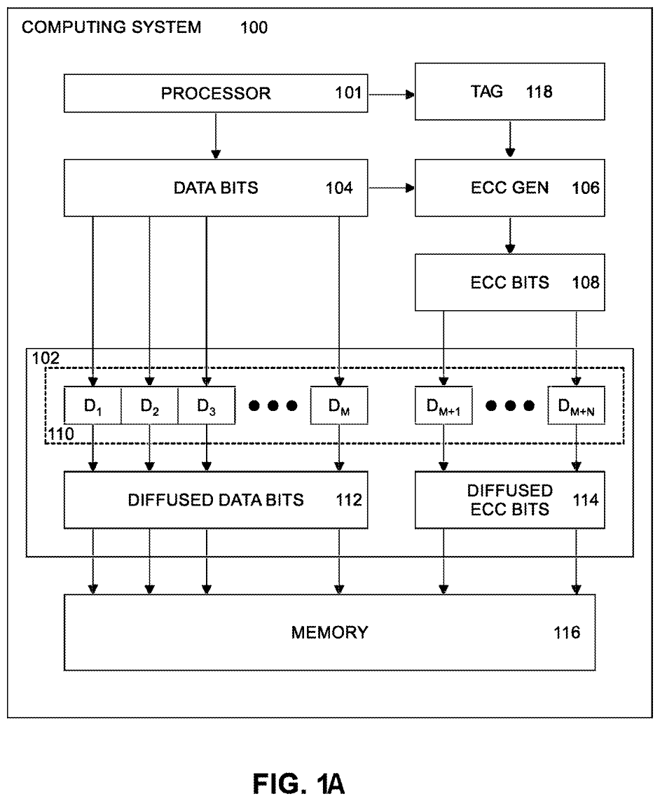

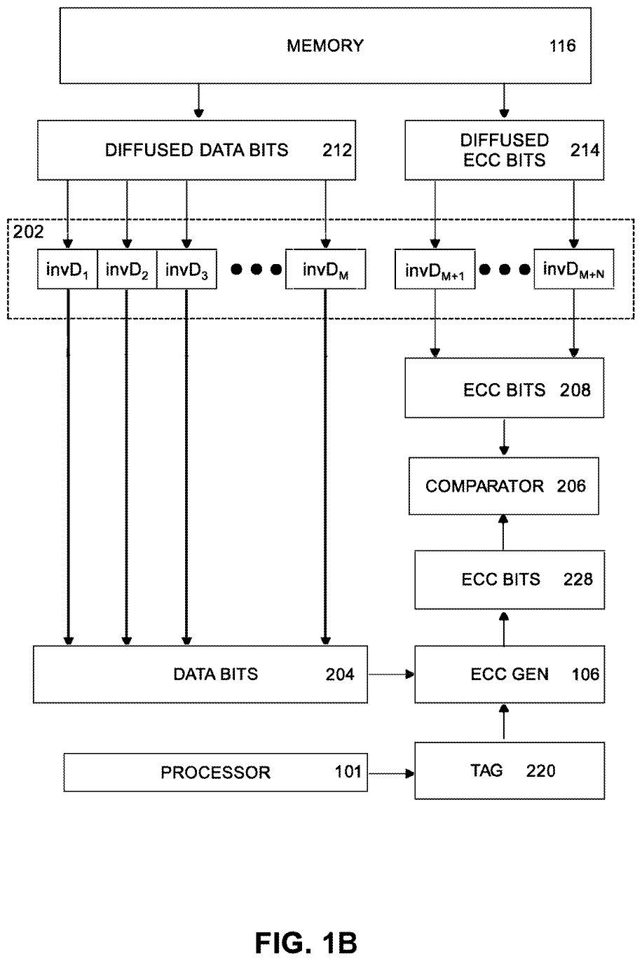

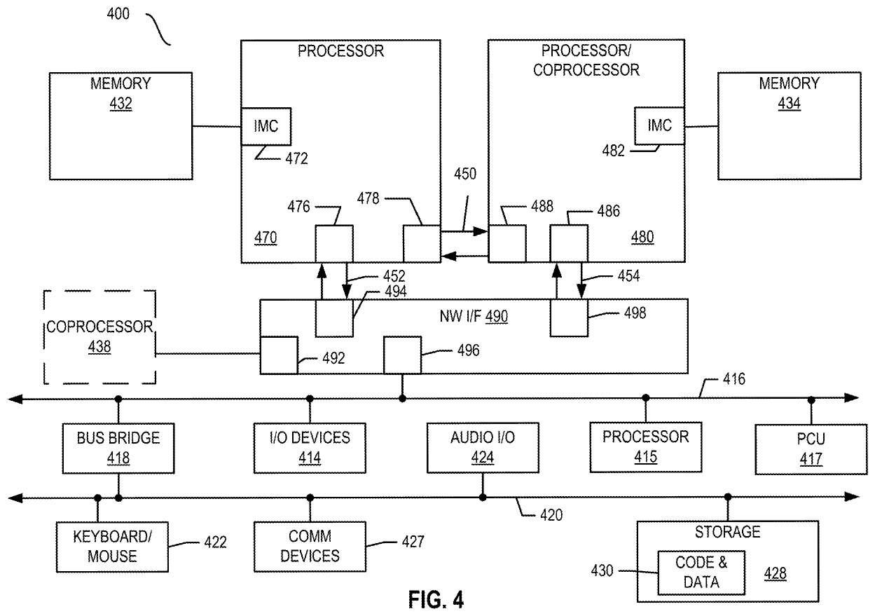

FIG. 1A illustrates an apparatus (e.g., a computing system) 100 for error correction with memory safety according to an embodiment. Apparatus 100 may correspond to a computer system such as multiprocessor system 400 in FIG. 4.

Apparatus 100 is shown in FIG. 1A as including a processor 101, ECC generation (gen) hardware 106, bijective diffusion function layer circuitry 102, and memory 116, each of which may represent any number of corresponding components (e.g., multiple processors and/or processor cores, multiple dynamic random-access memories (DRAMs), etc.) Apparatus 100 may include ECC gen hardware 106 and bijective diffusion function layer circuitry 102 to perform error correction with memory safety and/or compartmentalization according to embodiments including a MAGIC technique.

For example, processor 101 may represent all or part of one or more hardware components including one or more processors, processor cores, or execution cores integrated on a single substrate or packaged within a single package, each of which may include multiple execution threads and/or multiple execution cores, in any combination. Each processor represented as or in processor 101 may be any type of processor, including a general-purpose microprocessor, such as a processor in the Intel® Core® Processor Family or other processor family from Intel® Corporation or another company, a special purpose processor or microcontroller, or any other device or component in an information processing system in which an embodiment may be implemented. Processor 101 may be architected and designed to operate according to any instruction set architecture (ISA), with or without being controlled by microcode.

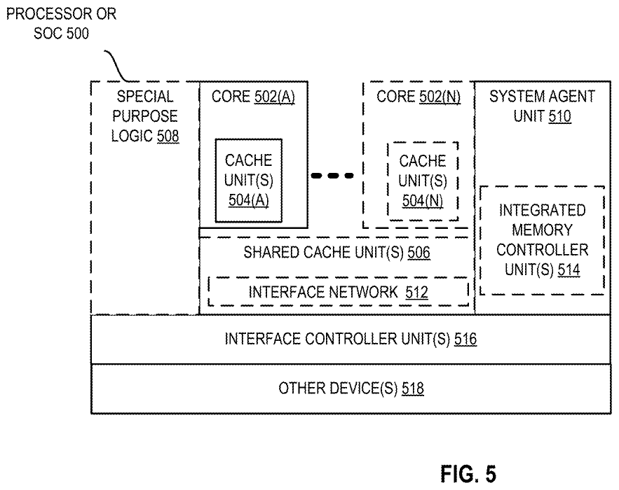

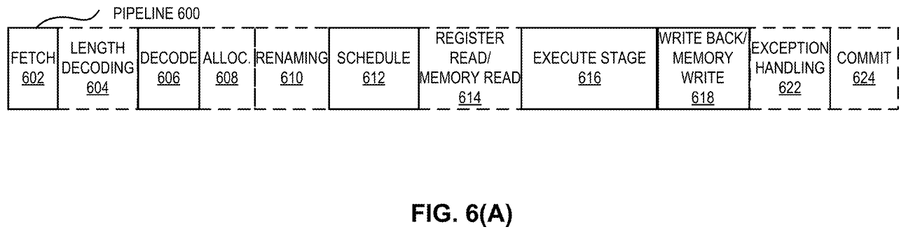

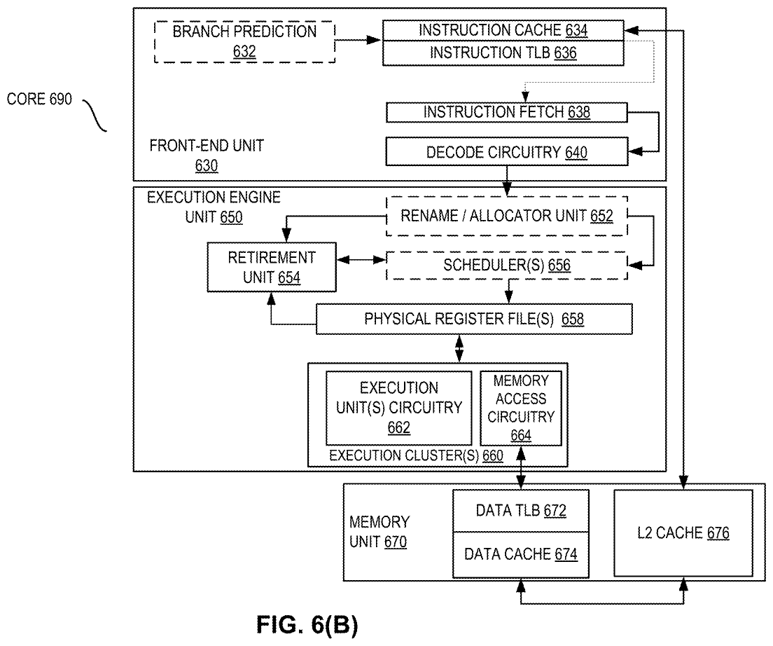

Processor 101 may be implemented in circuitry, gates, logic, structures, hardware, etc., all, or parts of which may be included in a discrete component and/or integrated into the circuitry of a processing device or any other apparatus in a computer or other information processing system. For example, processor 101 in FIG. 1A may correspond to and/or be implemented/included in any of processors 470, 480, or 415 in FIG. 4, processor 500 or one of cores 502A to 502N in FIG. 5, and/or core 690 in FIG. 6(B), each as described below.

Similarly, ECC generation hardware 106 may represent all or part of one or more hardware components, implemented in circuitry, gates, logic, structures, hardware, etc., partially separate from or wholly or partially included in or integrated into one or more processor(s) (e.g., processor 101), system on a chip (SoC), memory controller(s), memory component(s) (e.g., memory 116), etc.

Memory 116 may represent one or more DRAMs and/or other memory components providing a system memory or other memory or storage in or for apparatus 100.

As shown by example in FIG. 1A, processor 101 may provide (e.g., in connection with the execution or performance of a data store or write instruction or operation) data bits 104 along with a corresponding tag 118 for storing in memory 116. Data bits 104 may represent a 512-bit cache line or any other number of bits of data.

Tag 118 may represent any number of bits of a tag, tag value, tag symbol, tag information, metadata, etc. that may be used to identify, protect, compartmentalize, etc. data bits 104 or any portion(s) of data bits 104. In embodiments, tag 118 is provided with, within, or appended to a memory address (e.g., a physical or system memory address provided) by processor 101 to indicate a location in memory 116 in which data bits 104 (or some derivation of them) is to be stored. In embodiments, additional metadata may be added to the memory requests and stored cache lines or associated with stored cache lines to carry the tag value.

In embodiments, tag 118 may represent or include a value that is associated, in some respect, to data bits 104 and/or a location in which data bits 104 (or some derivation of them) is to be stored. For example, data bits 104 may correspond to (e.g., based on an address of a memory location in which it is stored or is to be stored) a specific cache line, and a cache policy may allow only one tag value per physical address to be present in the cache at a given time (e.g., to avoid issues with aliasing). In other words, two load/store operations to the same physical memory location with different tag values may result in a cache line corresponding to that memory location to be invalidated and/or evicted from the cache).

In embodiments, tag 118 may represent a value to indicate ownership, permission, authorization, categorization, etc. of data bits (or one or more portion(s) of data bits) 104 and/or the actual or intended location of data bits 104 (or portion(s)) in memory. In embodiments, tag 118 may represent or include a key or identifier of a key to be used to encrypt or decrypt data bits (or portion(s) of data bits) 104.

In embodiments, tag 118 may represent or include a value that is unique to one or more users, applications, containers, etc. (each of which may be referred to for convenience as a user), such that if a user attempts to access corresponding (e.g., based on linear or virtual address of memory location provided by the user and physical address of memory location in which data is stored) data without providing a matching tag value (e.g., in, appended to, associated with, etc. the linear or virtual address provided by the user), the access will be denied. Therefore, tag 118 may be used as part of a mechanism to secure, protect, compartmentalize, etc. data. This is distinct in that the tag is being checked against an assumed value rather than the tag being additionally stored. It is a question of whether a provided tag is correct or incorrect rather than recovering what the tag value should be.

As shown in FIG. 1A, tag 118 is used with data bits 104 (e.g., as or to construct an additional Reed-Solomon symbol) as an input to ECC generation circuitry 106, such that ECC bits 108 are based not only on data symbols (e.g., data bits 104), but also on the provided tag symbol(s) (e.g., tag 118). For example, each tag value may be encoded as one or more symbols that are used together with data symbols to generate ECC bits, i.e., tag symbols are treated as additional data symbols during ECC generation. In an alternative implementation (which may be mathematically the same), unique bit pattern values for each tag value may be exclusively ORed (XORed) into the ECC bits that are generated based on the data symbols only.

Unlike data symbols, these tag symbols are not stored explicitly in memory, but nevertheless are used to verify the correctness of the provided tag value from the processor (e.g., tag values are provided on a read request to perform ECC checking and/or error correction), as described below.

As ECC symbols may be computed for various parts of a cache line (such as a first half with a corresponding ECC code and a second half with a corresponding ECC code, the tag symbol may be checked against the processor provided tag value independently for each half of the cache line. Embodiments may further divide the cache line into quarters with ECC symbols devoted to each quarter of a cache line and the tag checks may then be at a finer granularity, checking the tag value for each quarter of a cache line against its associated quarter of ECC symbols, and so on.

Additionally, as shown in FIG. 1A, for example, data bits 104 and ECC bits 108 may be divided into blocks and a bijective diffusion function D is applied to each block by a bijective diffusion function layer 102 including bijective diffusion function circuits D₁ to D_{M} to transform data bits 104 to diffused data bits 112 and bijective diffusion function circuits D_{M+1} to D_{M+N} to transform ECC bits 108 to diffused ECC bits 114. In an implementation, the number M of bijective diffusion function circuits D₁ to D_{M} may be sixteen (e.g., to diffuse a 512-bit cache line) and the number N of bijective diffusion function circuits D_{M+1} to D_{M+N} may be four (e.g., to diffuse a corresponding ECC value). In other implementations, M may be any natural number and N may be any natural number, each of which may depend on the number of data bits (e.g., 64, 128, 256, 512, 1024, etc.) and ECC bits (2, 4, 8, 16, 32, etc.), respectively, and/or the number of data bits (e.g., 2, 4, 8, 16, 32, etc.) and ECC bits (e.g., 2, 4, 8, 16, 32, etc.) to be diffused per bijective diffusion function circuit.

In various implementations, each of the M bijective diffusion function circuits and/or the N bijective diffusion function circuits may be instances of the same circuit, or at least one may be different, and/or an index may be used as an input tweak so that two of more outputs are not correlated even if two or more inputs are the same. In an embodiment, the bijective diffusion function may be a block cipher that may be tweakable. For example, an 8-bit tweakable block cipher may be implemented as a series of look-up tables containing random permutations of values 0 to 255, where each tweak addresses a different look-up table.

In various embodiments, data (e.g., data bits 104, diffused data bits 112) and ECC (e.g., ECC bits 108, diffused ECC bits 114) symbols may be encrypted (e.g., before diffusion, after diffusion) after ECC generation using a secret key, then the encrypted versions stored in memory 116. In alternative embodiments, data (e.g., data bits 104) and tag (e.g., tag 118) symbols may be encrypted before ECC generation and the resulting ciphertext value used to generate the ECC bits, such that the plaintext data or the diffused plaintext data may be stored in memory and the ciphertext used to generate the ECC bits is hidden.

FIG. 1B illustrates an example of the operation of apparatus 100 in connection with the execution or performance of a data load or read instruction or operation according to an embodiment (or an attempt to execute or perform a data load or read instruction or operation, which may be blocked if the correct tag is not provided in connection with the attempt).

As shown by example in FIG. 1B, processor 101 (e.g., in connection with the execution or performance of a data load instruction or operation) may provide a tag 220 with, within, or appended to a memory address (e.g., a physical or system memory address) that indicates a location in memory 116 from which data (or some derivation of data) is to be loaded, and memory 116 may provide (e.g., in connection with the execution or performance by processor 101 of the data load or read instruction or operation) diffused data bits 212 from the memory location along with corresponding diffused ECC bits 214.

As shown in FIG. 1B, for example, diffused data bits 212 and diffused ECC bits 214 are divided into blocks and an inverse bijective diffusion function D is applied to each block by an inverse bijective diffusion function layer 202 including inverse bijective diffusion function circuits invD₁ to invD_{M} to transform diffused data bits 212 to data bits 204 and inverse bijective diffusion function circuits invD_{M+1} to invD_{M+N} to transform diffused ECC bits 214 to ECC bits 208.

As shown in FIG. 1B, tag 220 is used with data bits 204 (e.g., as or to construct an additional Reed-Solomon symbol) as an input to ECC generation circuitry 106, such that ECC bits 228 are based on data symbols (e.g., data bits 204) and tag symbol(s) (e.g., tag 220).

As shown in FIG. 1B, ECC bits 228 may be compared (e.g., by comparator circuit 206) to ECC bits 208 to determine if there are one or more errors in the stored data and/or if the incorrect tag was used in the attempt to read the data, as further described below.

In various embodiments, depending on the encryption scheme used to store the data and using the secret key used for encryption, data (e.g., data bits 204, diffused data bits 212) and/or tag (e.g., tag 220) symbols may be decrypted before ECC generation and/or ECC (e.g., ECC bits 208, diffused ECC bits 214) symbols may be decrypted before comparison with ECC bits 228. Embodiments may include applying the ECC tag check symbols without requiring any additional encryption/decryption or diffusion of the cache line or portions thereof.

In various embodiments, one or more ECC values (and/or results of ECC comparisons such as between ECC bits 208 and ECC bits 228) may be used to detect and/or correct errors in the data symbols and/or identify incorrect tag symbols. For example, in a chipkill implementation, an uncorrectable error may be detected if the user provided an incorrect tag (and, for example, the read attempt may be blocked and/or the loaded cache line may be marked as invalid by setting a corresponding poison bit); otherwise (i.e., the user provided the correct tag), the ECC values may be used to correct the data.

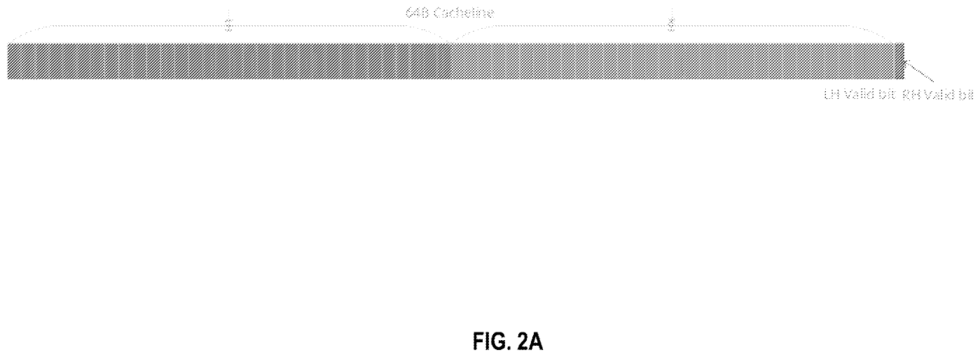

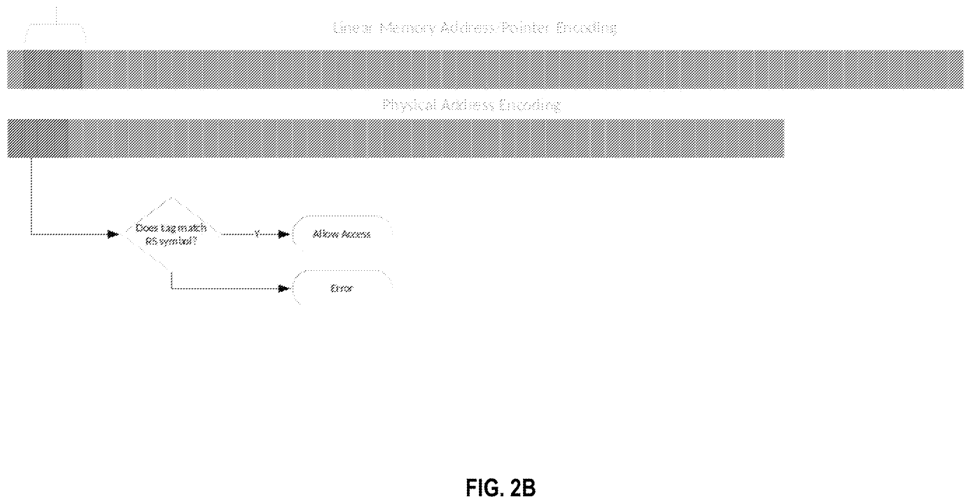

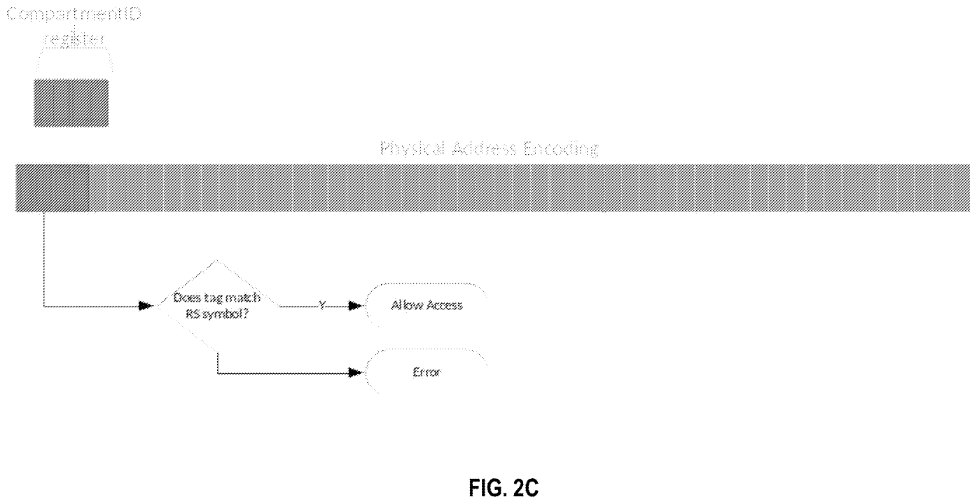

In various embodiments, ECC values may be split across a cache line. For example, as shown in FIG. 2A, a 64B cache line may be split into a 32B left half and a 32B right half by generating (e.g., in connection with a store operation) ECC value(s) with different tags for the left and right half in connection with a store operation, then testing (e.g., in connection with a read operation) a tag (for convenience to be referred to as a read tag) against both halves individually. If testing the read tag against the right half results in a match, then the data read into to right half of the cache line may be marked as valid (e.g., by setting a right-half valid bit or clearing a right-half poison bit), if testing the read tag against the left half results in a match, then the data read into the left half of the cache line may be marked as valid (e.g., by setting a left-half valid bit or clearing a left-half poison bit). In some instances, the same tag may be used (e.g., in connection with a store operation) for both sides, in which case (in connection with a read operation) use of a correct read tag may result in both the right and left sides being marked valid and use of an incorrect read tag may result in both the right and left sides being marked invalid.

Similarly, cache lines of any size may be divided into any number of portions (e.g., halves, quarters, etc.). For example, if the cache line were divided into quarters, ECC symbols would be provided for each quarter including an associated tag symbol for each quarter. Instead of a left half and right half valid bit associated with each cache line in the cache, bits indicating which quarters of the line are valid may be used. Embodiments may further codify these bits as contiguous sets that are valid to lessen the amount of stored valid bits.

Instead of adding additional bits to indicate which portions of a cache line are valid for a tag as stored in cache, special data values may be used to indicate invalid regions of a cache line. For example, a random number of 32 bytes may be used to indicate only the second half of a cache line is invalid, where the random number is improbable to conflict with a real data value. This random value may be selected at processor boot time and signify to the processor that a cache line portion is invalid and, thus, any attempts to read from that portion of the cache line should trigger an error, fault, exception, or other indication to software to mitigate the error.

In embodiments, if read tag(s) testing results in a determination that a correct read tag was used (for at least a portion of a cache line), the processor may load the cache line into a data cache or data cache unit (e.g., any of cache units 504A to 504N in FIG. 5, a first level cache such as data cache 674 in FIG. 6(B)). If read tag(s) testing results in a determination that an incorrect (or no) read tag was used (for at least a portion of the cache line), an error, fault, exception, etc. may be triggered in the processor (e.g., to allow a privileged software handler to run and determine an appropriate response to an invalid memory access). In embodiments, privileged instructions or direct writes may be used to update tag values for cache lines or portions of cache lines written to memory to change ownership (e.g., to update only the right or left half of the cache line).

In embodiments, for example as shown in FIG. 2B, a tag, tag value, tag symbol, etc. may be provided in, with, as a portion of, etc. (or derived from) a linear address, pointer, etc., in connection with a load, read, store, write, etc. operation, then copied into a portion of, appended to, etc. a physical address so it may be passed through the cache hierarchy to the hardware (e.g., memory controller) that performs or manages the ECC encoding. Tags may be added to physical addresses independently of address translations (e.g., translation lookaside buffer (TLB) translations) for more efficient address translation (e.g., TLB) performance.

In embodiments, a tag may be used to identify or otherwise provide association with one or more compartments, contexts, containers, virtual machines, etc. Therefore, embodiments may be used for memory compartmentalization at various granularities (e.g., half, quarter, etc. of a cache line as described above).

For example, as shown in FIG. 2C, a tag may be stored in a register in the processor (e.g., a context or compartment identification (ID) register) for a currently executing context or compartment on a hardware thread or core. A processor hardware thread may have one or more such registers (to be referred to as compartment ID registers) to provide for private and/or shared memory accesses. In implementations with multiple compartment ID registers, a linear address (e.g., provided by a user, application, container, etc., each of which may be referred to for convenience as a user), may include (or otherwise have appended to or associated with it) a bit or field for a value to indicate which compartment ID register (e.g., the private compartment ID register for a user or a shared compartment ID register), such that users may keep some data private and share or exchange other data with other users. Like a tag, this value to identify the compartment ID register may be copied into a portion of, appended to, etc. a physical address such that the value or content from the indicated register may be used a tag for ECC generation and comparison according to embodiments and/or as described above.

Various embodiments may include any number of tags and/or compartment ID registers and/or may include any number of bits in tags and/or compartment ID registers. Various embodiments may include tag information as separate metadata associated with individual cache lines.

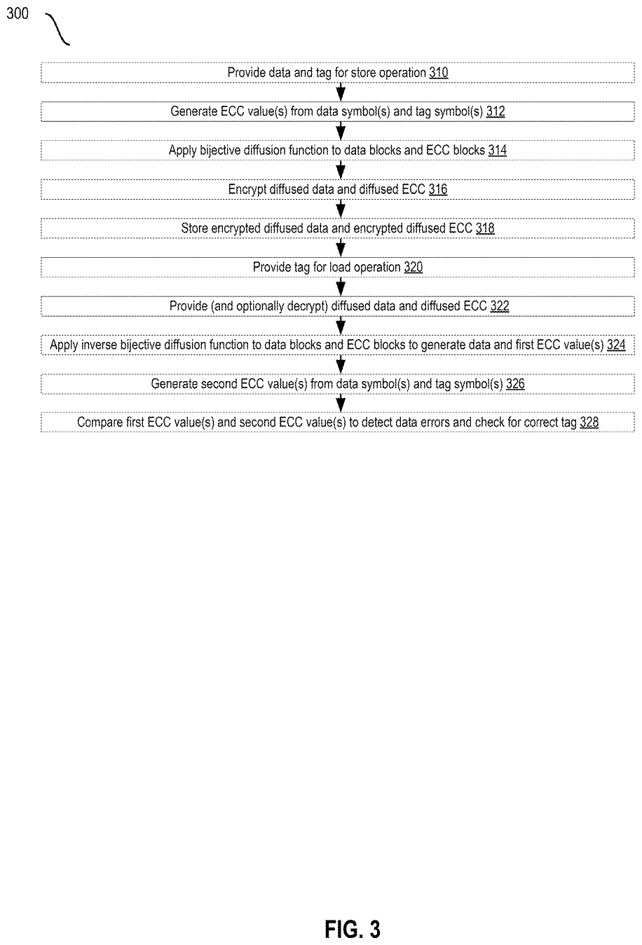

FIG. 3 illustrates a method 300 for error correction with memory safety and compartmentalization according to an embodiment. Method 300 may be performed by and/or in connection with the operation of an apparatus such as apparatus 100 in FIG. 1A; therefore, all or any portion of the preceding description of apparatus 100 may be applicable to method 300.

In 310, data (e.g., data bits 104) and a tag (e.g., tag 118) may be provided (e.g., by processor 101 in connection with the execution or performance of a data store or write instruction or operation) for storing in a memory (e.g., memory 116).

In 312, the tag is used with the data (e.g., as or to construct an additional Reed-Solomon symbol) to generate (e.g., by ECC generation circuitry 106) one or more ECC value(s), such that the ECC value(s) are based not only on data symbol(s) (e.g., data bits 104), but also on tag symbol(s) (e.g., tag 118).

In 314, the data and the ECC value are divided into blocks and a bijective diffusion function D is applied to each block by a bijective diffusion function layer (e.g., including bijective diffusion function circuits D₁ to D_{M} to transform the data bits to diffused data bits and bijective diffusion function circuits D_{M+1} to D_{M+N} to transform the ECC bits to diffused ECC bits).

In 316, the diffused data bits and the diffused ECC bits are encrypted.

In 318, the encrypted diffused data bits and encrypted diffused ECC bits are stored in memory.

Note that one or more actions, operations, etc. included in method 300 may be performed differently and/or in a different order and/or in parallel; for example, encryption of data bits and the tag may be performed before ECC generation.

In 320, a tag 220 is provided (e.g., by processor 101) with, within, or appended to a memory address (e.g., a physical or system memory address) that indicates a location in memory 116 from which data (or some derivation of data) is to be loaded.

In 322, diffused data bits (e.g., diffused data bits 212) along with corresponding diffused ECC bits (e.g., diffused ECC bits 214) are provided (e.g., in connection with the execution or performance of the data load or read instruction or operation) and, in some embodiments, decrypted.

In 324, the diffused data bits and the diffused ECC bits are divided into blocks and an inverse bijective diffusion function D is applied to each block by an inverse bijective diffusion function layer (e.g., inverse bijective diffusion function layer 202) including inverse bijective diffusion function circuits (e.g., invD₁ to invD_{M}) to transform the diffused data bits to data bits (e.g., data bits 204) and inverse bijective diffusion function circuits (e.g., invD_{M+1} to invD_{M+N}) to transform the diffused ECC bits to a first set of ECC bits (e.g., ECC bits 208).

In 326, the tag is used with the data bits (e.g., as or to construct an additional Reed-Solomon symbol) as an input to ECC generation circuitry (e.g., ECC gen 106), such that a second set of ECC bits (e.g., ECC bits 228) are based on data symbol(s) (e.g., data bits 204) and tag symbol(s) (e.g., tag 220).

In 328, the second set of ECC bits are compared (e.g., by comparator circuit 206) to the first set of ECC bits to determine if there are one or more errors in the stored data and/or if an incorrect tag was used in the attempt to read the data (e.g., whether tag 220 matches tag 118).

According to some examples, an apparatus includes a processor to provide a first set of data bits and a first tag in connection with a store operation, and an error correcting code (ECC) generation circuit to generate a first set of ECC bits based on a first set of data bits and a first tag.

According to some examples, a method includes providing, by a processor in connection with a store operation, a first set of data bits and a first tag; generating, by an error correcting code (ECC) generation circuit, a first set of ECC bits based on the first set of data bits and the first tag; and storing the first set of data bits and the first set of ECC bits in a memory.

Any such examples may include any or any combination of the following aspects. The apparatus may also include a memory to store the first set of data bits and the first set of ECC bits. The ECC generation circuit may also be to generate the first set of ECC bits from Reed-Solomon input symbols based on the first set of data bits and the first tag. The first set of data bits may be encrypted. The first set of ECC bits may be encrypted. The first tag may be encrypted. The ECC generation circuit may also be to generate a second set of ECC bits based on a second set of data bits and a second tag, wherein the second set of data bits is read from the memory. The processor may be to provide the second tag in connection with a load operation. The apparatus may also include a comparator to compare the second set of ECC bits and a third set of ECC bits, the third set of ECC bits to be read from the memory. The apparatus may also include a cache, the first set of data bits may correspond to a first portion of a cache line, the ECC generation circuit may also be to generate a fourth set of ECC bits based on a third set of data bits and the first tag, the third set of data bits correspond to a second portion of the cache line, the fourth set of ECC bits are to be stored in the memory. The ECC generation circuit may also be to generate a fifth set of ECC bits based on a fifth set of data bits and a third tag, the fifth set of ECC bits to be read from the memory; and the comparator may also be to compare the fifth set of ECC bits and the fourth set of ECC bits, the fourth set of ECC bits to be read from the memory. The processor may be to provide the third tag in connection with the load operation. The cache line may include a first valid bit corresponding to the first portion of the cache line and a second valid bit corresponding to the second portion of the cache line; the first valid bit may be marked invalid in response to the comparator detecting a mismatch between the second set of ECC bits and the third set of ECC bits; and the second valid bit may be marked invalid in response to the comparator detecting a mismatch between the fifth set of ECC bits and the fourth set of ECC bits. The processor may include a register to store the second tag. The apparatus may also include a first plurality of bijective diffusion function circuits to diffuse the first set of data bits into a first set of diffused data bits; a second plurality of bijective diffusion function circuits to diffuse the first set of ECC bits into of first set of diffused ECC bits; and a memory to store the first set of diffused data bits and the first set of diffused ECC bits. The apparatus may also include a first plurality of inverse bijective diffusion function circuits to generate a second set of data bits from the first set of diffused data bits stored in the memory; and a second plurality of inverse bijective diffusion function circuits to generate a second set of ECC bits from the first set of diffused ECC bits stored in the memory. The method may also include providing, by the processor in connection with a load operation, a second tag; reading a second set of data bits and a second set of ECC bits from the memory; generating, by the ECC generation circuit, a third set of ECC bits based on the second set of data bits and the second tag; and comparing the second set of ECC bits and the third set of ECC bits to determine whether the second tag matches the first tag.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures-In-Order and Out-of-Order Core Block Diagram.

FIG. 6(A) is a block diagram illustrating both an example in-order pipeline and an example register renaming, out-of-order issue/execution pipeline according to examples. FIG. 6(B) is a block diagram illustrating both an example in-order architecture core and an example register renaming, out-of-order issue/execution architecture core to be included in a processor according to examples. The solid lined boxes in FIGS. 6(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6(A), a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6(B) may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6(B) shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding. LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry.

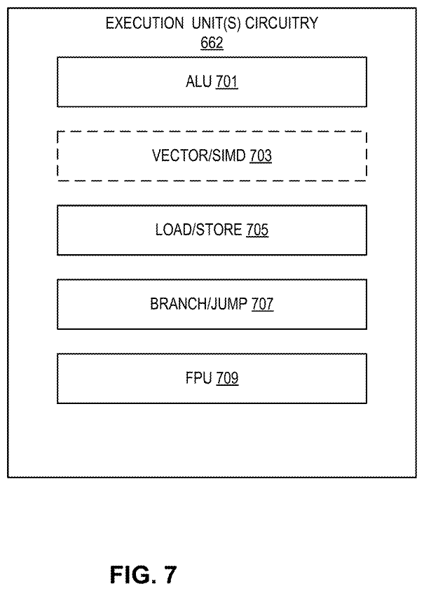

FIG. 7 illustrates examples of execution unit(s) circuitry, such as execution unit(s) circuitry 662 of FIG. 6(B). As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

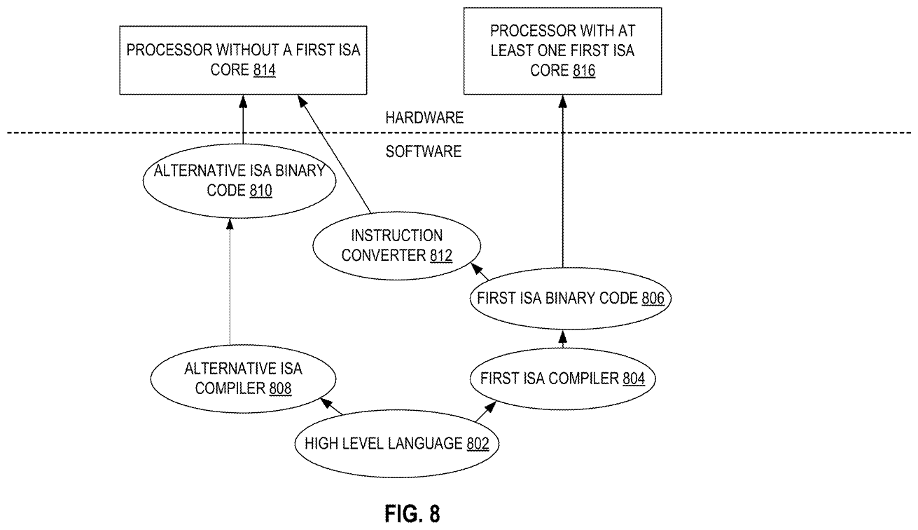

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases are not necessarily referring to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a processor to provide a first set of data bits and a first tag in connection with a store operation; and
an error correcting code (ECC) generation circuit to generate a first set of ECC bits based on a first set of data bits and a first tag.

2. The apparatus of claim 1, further comprising a memory to store the first set of data bits and the first set of ECC bits.

3. The apparatus of claim 1, wherein the ECC generation circuit is to generate the first set of ECC bits from Reed-Solomon input symbols based on the first set of data bits and the first tag.

4. The apparatus of claim 1, wherein the first set of data bits are encrypted.

5. The apparatus of claim 1, wherein the first set of ECC bits are encrypted.

6. The apparatus of claim 1, wherein the first tag is encrypted.

7. The apparatus of claim 2, wherein the ECC generation circuit is also to generate a second set of ECC bits based on a second set of data bits and a second tag, wherein the second set of data bits is read from the memory.

8. The apparatus of claim 7, wherein the processor is to provide the second tag in connection with a load operation.

9. The apparatus of claim 8, further comprising a comparator to compare the second set of ECC bits and a third set of ECC bits, the third set of ECC bits to be read from the memory.

10. The apparatus of claim 9, further comprising a cache, wherein:
the first set of data bits corresponds to a first portion of a cache line; and
the ECC generation circuit is also to generate a fourth set of ECC bits based on a third set of data bits and the first tag, wherein the third set of data bits corresponds to a second portion of the cache line and the fourth set of ECC bits is to be stored in the memory.

11. The apparatus of claim 10, wherein:
the ECC generation circuit is also to generate a fifth set of ECC bits based on a fifth set of data bits and a third tag, the fifth set of ECC bits to be read from the memory; and
the comparator is also to compare the fifth set of ECC bits and the fourth set of ECC bits, the fourth set of ECC bits to be read from the memory.

12. The apparatus of claim 11, wherein the processor is to provide the third tag in connection with the load operation.

13. The apparatus of claim 11, wherein:
the cache line includes a first valid bit corresponding to the first portion of the cache line and a second valid bit corresponding to the second portion of the cache line;
the first valid bit is to be marked invalid in response to the comparator detecting a mismatch between the second set of ECC bits and the third set of ECC bits; and
the second valid bit is to be marked invalid in response to the comparator detecting a mismatch between the fifth set of ECC bits and the fourth set of ECC bits.

14. The apparatus of claim 8, wherein the processor includes a register to store the second tag.

15. The apparatus of claim 1, further comprising:
a first plurality of bijective diffusion function circuits to diffuse the first set of data bits into a first set of diffused data bits;
a second plurality of bijective diffusion function circuits to diffuse the first set of ECC bits into of first set of diffused ECC bits; and
a memory to store the first set of diffused data bits and the first set of diffused ECC bits.

16. The apparatus of claim 15, further comprising:
a first plurality of inverse bijective diffusion function circuits to generate a second set of data bits from the first set of diffused data bits stored in the memory; and
a second plurality of inverse bijective diffusion function circuits to generate a second set of ECC bits from the first set of diffused ECC bits stored in the memory.

17. A method comprising:
providing, by a processor in connection with a store operation, a first set of data bits and a first tag;
generating, by an error correcting code (ECC) generation circuit, a first set of ECC bits based on the first set of data bits and the first tag; and
storing the first set of data bits and the first set of ECC bits in a memory.

18. The method of claim 17, further comprising:
providing, by the processor in connection with a load operation, a second tag;
reading a second set of data bits and a second set of ECC bits from the memory;
generating, by the ECC generation circuit, a third set of ECC bits based on the second set of data bits and the second tag; and
comparing the second set of ECC bits and the third set of ECC bits to determine whether the second tag matches the first tag.

19. A non-transitory machine-readable medium storing at least one instruction which, when executed by a machine, causes the machine to perform a method comprising:
providing, by a processor in connection with a store operation, a first set of data bits and a first tag;
generating, by an error correcting code (ECC) generation circuit, a first set of ECC bits based on the first set of data bits and the first tag; and
storing the first set of data bits and the first set of ECC bits in a memory.

20. The non-transitory machine-readable medium of claim 19, wherein the method further comprises:
providing, by the processor in connection with a load operation, a second tag;
reading a second set of data bits and a second set of ECC bits from the memory;
generating, by the ECC generation circuit, a third set of ECC bits based on the second set of data bits and the second tag; and
comparing the second set of ECC bits and the third set of ECC bits to determine whether the second tag matches the first tag.
